(19) United States
(12) Patent Application Publication
(10) Pub. No.: US 2014/0341604 A1
(43) Pub. Date: Nov. 20, 2014

(54) IMAGE FORMING APPARATUS, CONTROL METHOD FOR IMAGE FORMING APPARATUS AND STORAGE MEDIUM

(71) Applicant: CANON KABUSHIKI KAISHA, Tokyo (JP)

(72) Inventor: Hiroshi Yamamizu, Yokohama-shi (JP)

(73) Assignee: CANON KABUSHIKI KAISHA, Tokyo (JP)

(21) Appl. No.: 14/280,419

(22) Filed: May 16, 2014

(30) Foreign Application Priority Data
May 20, 2013 (JP) 2013-106094

(51) Int. Cl. G03G 15/00

(52) U.S. Cl. CPC G03G 15/80
USPC 399/88

(57) ABSTRACT

When a job is received via a LAN and if power for a controller unit is not turned on, a LAN controller of an image forming apparatus turns on a switch and performs an operation to turn on the power for the controller unit. If the power for the controller unit is not turned on even after the operation is performed or if the main switch is turned off, the LAN controller of the image forming apparatus notifies a job sender to connect AC power supply or turn on a main switch.

### BACKGROUND

1. Field

Aspects of the present invention generally relate to a control method for an image forming apparatus capable of receiving power via a communication medium even if the image forming apparatus is in a powered off state.

2. Description of the Related Art

Conventionally, there are techniques used for supplying power to an electronic apparatus via a network cable or via a universal serial bus (USB) cable. The former is called Power over Ethernet® (PoE).

Japanese Patent Application Laid-Open No. 2010-41307 discusses a method for supplying power to an image forming apparatus using PoE when a main power supply of the apparatus is turned off. This helps to protect data stored in the image forming apparatus.

According to the image forming apparatus discussed in Japanese Patent Application Laid-Open No. 2010-41307, however, if the image forming apparatus receives a print request after a power feeding source is changed from the main power supply to PoE, power cannot be supplied to a printing unit that executes printing unless a mechanical switch is turned on by a user. Thus, in the above-described case, the image forming apparatus discussed in Japanese Patent Application Laid-Open No. 2010-41307 notifies a sender of the print request that printing cannot be performed.

### SUMMARY

Aspects of the present invention are generally directed to an image forming apparatus capable of supplying power to a control unit that controls the image forming apparatus without a user operating the image forming apparatus, when the image forming apparatus receives a wake-up request from a network in a case where power is supplied to a network interface unit of the image forming apparatus via a network cable which connects the network interface unit and the network.

According to an aspect of the present invention, an image forming apparatus having a switch turned on or off according to an operation of a user includes a control unit configured to control the image forming apparatus, a network interface unit configured to receive data transmitted from an external apparatus, and a power supply unit configured to supply power to the control unit if the network interface unit receives a wake-up request transmitted from the external apparatus when power is supplied to the network interface unit via a network cable that connects the network interface unit and a network.

Further features of the present disclosure will become apparent from the following description of exemplary embodiments with reference to the attached drawings.

### BRIEF DESCRIPTION OF THE DRAWINGS

FIG. 1 illustrates a network system including an image forming apparatus.

FIG. 2 illustrates an outer appearance of the image forming apparatus.

FIG. 3 illustrates a configuration of a controller of the image forming apparatus according to a first exemplary embodiment.

FIG. 4 illustrates a hardware configuration of the image forming apparatus associated with power control according to the first exemplary embodiment.

FIG. 5 is a flowchart illustrating power control of the image forming apparatus according to the first exemplary embodiment.

FIG. 6 illustrates the image forming apparatus in an energized state according to the first exemplary embodiment.

FIG. 7 illustrates the image forming apparatus in an energized state according to the first exemplary embodiment.

FIG. 8 illustrates the image forming apparatus in an energized state according to the first exemplary embodiment.

FIG. 9 illustrates a hardware configuration of the image forming apparatus associated with power control according to a second exemplary embodiment.

### DESCRIPTION OF THE EMBODIMENTS

Various exemplary embodiments will be described in detail below with reference to the drawings.

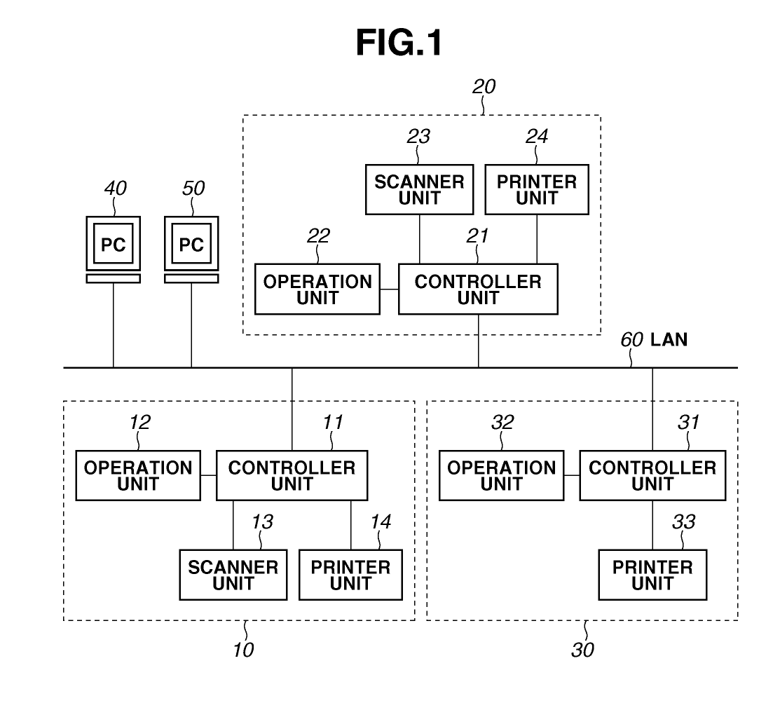

FIG. 1 illustrates a block diagram of a configuration example of a network system including an image forming apparatus being an example of an electronic apparatus.

Although personal computers (PC) 40 and 50, which are host computers, and image forming apparatuses 10, 20, and 30 are connected to a local area network (LAN) 60 in FIG. 1, the system according to the present invention is not limited to these numbers of the apparatuses. Further, although a LAN is used for connecting the apparatuses according to the present embodiment, connection methods other than the LAN are applicable. For example, an arbitrary network such as a USB network or a wide area network (WAN) (a public line) can also be used.

Each of the host computers (hereinafter PCs) 40 and 50 has a function of a personal computer. By using a file transfer protocol (FTP) or a server message block (SMB) protocol, the PC 40 can transmit/receive a file or an electronic mail via the LAN 60 or a WAN. Further, each of the PCs 40 and 50 can issue a print command to the image forming apparatuses 10, 20, and 30 via a printer driver. Furthermore, each of the PCs 40 and 50 can inquire each of the image forming apparatuses 10, 20, and 30 about its state at regular intervals. When each of the image forming apparatuses 10, 20, and 30 receives a request from the PC 40 or 50, it can provide the PC 40 or 50 with information, for example, as to whether it can perform printing.

The image forming apparatus 10 and the image forming apparatus 20 have a same configuration. The function of the image forming apparatus 30 is limited to printing. More precisely, it does not have a scanner unit, which is included in the image forming apparatuses 10 and 20. In the description below, the configuration of the image forming apparatus 10 out of the image forming apparatuses 10, 20, and 30 will be described in detail as a representing apparatus. The description of the image forming apparatuses 20 and 30 will be omitted.

The image forming apparatus 10 includes a scanner unit 13, a printer unit 14, a controller unit 11, and an operation unit 12. The scanner unit 13 is an image input device. The printer unit 14 is an image output device. The controller unit 11 controls the operation of the entire image forming apparatus 10. The operation unit 12 functions as a user interface (UI).

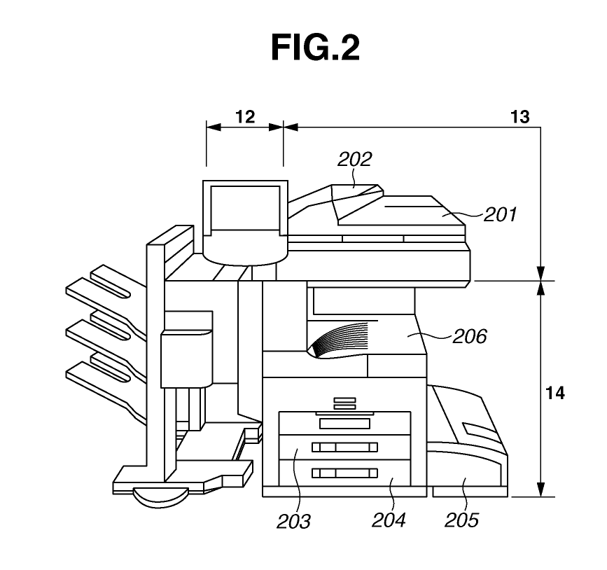

FIG. 2 illustrates an example of an outer appearance of the image forming apparatus 10.

The scanner unit 13 includes a plurality of charge-coupled devices (CCDs). When a document is scanned, if the sensitivity of each CCD is different, the density of each pixel is determined as different even if the density of each pixel of the document is equal. Thus, the scanner unit 13 firstly performs exposure scanning of a plate which is uniformly white, and then converts the amount of reflected light obtained from such exposure scanning into an electric signal. The electric signal is output to the controller unit 11. The configuration of the scanner unit 13 that scans an image on the document will be described.

The scanner unit 13 inputs the reflected light, which was obtained by the exposure scanning of the image on the document, in the CCD, and converts the information of the image into an electric signal. Further, the scanner unit 13 converts the electric signal into a luminance signal of each of R, G, and B colors, and outputs the luminance signal to the controller unit 11 as image data.

The document is set on a tray 202 of a document feeder 201. When the user instructs the image forming apparatus to start reading of the document via the operation unit 12, a document reading instruction is issued from the controller unit 11 to the scanner unit 13. When the scanner unit 13 receives the instruction, the document is fed, one sheet at a time, from the tray 202 of the document feeder 201. Then, the scanner unit 13 reads the document. The reading method of a document is not limited to an automatic feeding method by the document feeder 201. For example, the document can also be scanned by the user setting the document on a platen (not illustrated) and by moving an exposure unit.

The printer unit 14 is an image forming device configured to form the image data received from the controller unit 11 on a sheet of paper. Although the image forming method according to the present exemplary embodiment is an electrophotographic method using a photosensitive drum or a photosensitive member belt, any image forming method is applicable. For example, the image forming method can be an ink jet method where an image is printed by ink discharged from an extremely small nozzle array onto a sheet of paper. Further, a plurality of paper cassettes 203, 204, and 205 are provided for the printer unit 14. These cassettes allow different print paper size or different print paper orientation. After the paper is printed, it is discharged on a discharge tray 206.

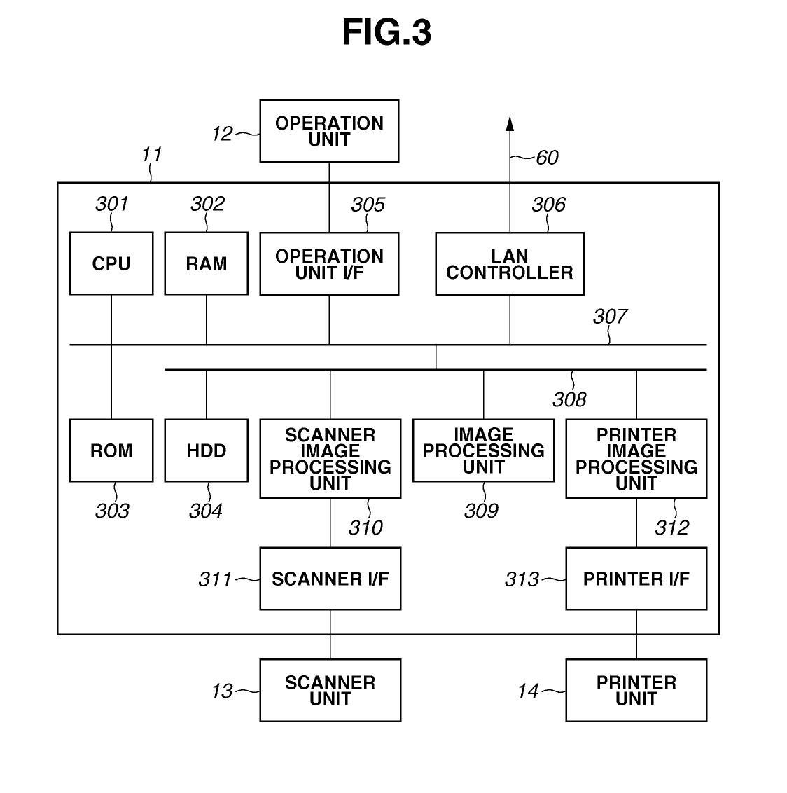

FIG. 3 is a block diagram illustrating the controller unit 11 of the image forming apparatus 10 according to a first exemplary embodiment.

The controller unit 11 is electrically connected to the scanner unit 13 and the printer unit 14. Further, the controller unit 11 is connected to the PCs 40 and 50 and also to an external apparatus via the LAN 60. Accordingly, image data and device information can be transmitted from such apparatuses to the controller unit 11 and output from the controller unit 11 to such apparatuses.

A central processing unit (CPU) 301 performs overall control of access to various devices, which are being connected, as well as performs overall control of various types of processing performed inside the controller unit 11 based on a control program stored in a read-only memory (ROM) 303. A random access memory (RAM) 302 is a system work memory used for an operation of the CPU 301. Image data is temporarily stored in the RAM 302. The RAM 302 includes a static random access memory (SRAM) and a dynamic RAM (DRAM). The content stored in the SRAM is maintained even when the supply of power is stopped whereas the content stored in the DRAM is deleted when the supply of power is stopped.

The ROM 303 stores a boot program of the image forming apparatus. A hard disk drive (HDD) 304 can store system software as well as image data. A storage device such as a solid state drive (SSD) can be used in place of the HDD 304.

An operation unit I/F 305 connects a system bus 307 and the operation unit 12. The operation unit I/F 305 receives image data to be displayed on the operation unit 12 from the system bus 307, and outputs it to the operation unit 12. Additionally, information input via the operation unit 12 is output to the system bus 307.

A LAN controller 306 connects the LAN 60 and the system bus 307. The LAN controller 306 is a communication control unit which controls input/output of information associated with data communication with the external apparatus via the LAN 60. Further, the LAN controller 306 includes a power receiving unit of PoE, and can receive power via a LAN cable even if the power supply of a main body of the image forming apparatus 10 is turned off. Thus, the LAN controller 306 can operate by the power supplied from PoE as well as by the power supplied from the power source of the image forming apparatus 10.

An image bus 308 is a transmission line which is used when image data is exchanged. The image bus 308 is, for example, a PCI bus or an IEEE 1394 bus. An image processing unit 309 performs image processing. The image processing unit 309 can perform image processing such as enlargement or reduction of a JPEG or JBIG image, color adjustment and such by reading out image data stored in the RAM 302.

A scanner image processing unit 310 performs correction, processing, and editing of the image data received from the scanner unit 13 via a scanner I/F 311. The scanner image processing unit 310 determines whether the received image data is a color or a monochrome document, and a text document or a photograph document. Further, the scanner image processing unit 310 attaches the result of the determination to the image data. The attached information is called attribute data.

A printer image processing unit 312 performs image processing of the image data while referring the attribute data attached to the image data. After the image data is subjected to the image processing, it is output to the printer unit 14 via a printer I/F 313.

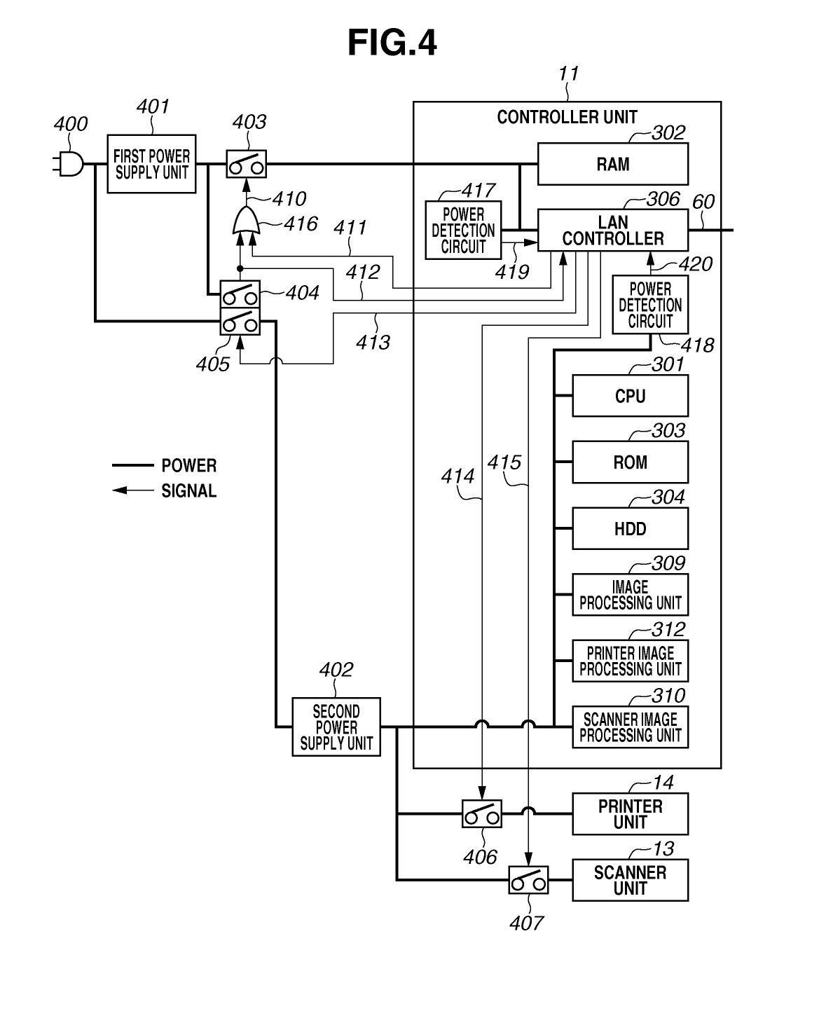

FIG. 4 is a block diagram of a hardware configuration of the controller unit 11, the scanner unit 13, and the printer unit 14 associated with the power control according to the first exemplary embodiment.

A power plug 400 connects an external power supply and the image forming apparatus 10. The external power supply is an alternating-current (AC) power supply.

A first power supply unit 401 converts AC power, which is supplied via the power plug 400, into DC power and supplies first power to the RAM 302 and the LAN controller 306 of the controller unit 11. The power supplied from the first power supply unit 401 is the power mainly reserved for the RAM 302 and the LAN controller 306 even if the image forming apparatus 10 is in a sleep state. Accordingly, even if the image forming apparatus 10 is in the sleep state, a job sent via the network can be detected by the power supplied from the first power supply unit 401.

A second power supply unit 402 converts AC power, which is supplied via the power plug 400, into DC power and supplies second power to each device included in the controller unit 11 as well as the scanner unit 13 and the printer unit 14. The second power supplied from the second power supply unit 402 is not supplied when the image forming apparatus 10 is in the sleep state. The second power supply unit 402 is provided so that power is not supplied to each device, which does not require the supply of power when the image forming apparatus 10 is in the sleep state. Accordingly, the power consumption of the image forming apparatus 10 in the sleep state can be reduced.

A switch 403 is turned on/off according to a control signal 410. A control signal 411 and a state notification signal 412 are input in an OR circuit 416. The control signal 411 is controlled by the LAN controller 306. The state notification signal 412 notifies the OR circuit 416 of the state of a main switch 404 operated by the user. When the control signal 411 or the state notification signal 412 is switched on, the control signal 410, which is output from the OR circuit 416, is switched on. When the switch 403 is turned on, the first power supplied from the first power supply unit 401 is supplied to the RAM 302 and the LAN controller 306. The switch 403 can be realized by, for example, a field effect transistor (FET) or a relay switch.

The user turns on/off the main switch 404 when the user determines to supply/not supply power to the image forming apparatus 10. If the user turns on the main switch 404, the control signal 412 is switched on and input in the OR circuit 416. Then, the control signal 410, which is switched on, is output from the OR circuit 416. When the control signal 410 is switched on, since the switch 403 will be turned on, the first power is supplied from the first power supply unit 401 to the RAM 302 and the LAN controller 306 included in the controller unit 11.

A switch 405 is turned on/off according to a control signal 413 which is controlled by the LAN controller 306. When the control signal 413 is switched on, power is supplied from the AC power supply to the second power supply unit 402. The switch 405 can be realized by, for example, a FET or a relay switch.

A switch 406 is turned on/off according to a control signal 414 which is controlled by the LAN controller 306. When the switch 406 is turned on, power is supplied from the second power supply unit 402 to the printer unit 14. The control signal 414 is switched on when the CPU 301 determines that the printer unit 14 is to be used. The switch 406 can be realized by, for example, a FET or a relay switch.

A switch 407 is turned on/off according to a control signal 415 which is controlled by the LAN controller 306. When the switch 407 is turned on, power is supplied from the second power supply unit 402 to the scanner unit 13. The control signal 415 is switched on when the CPU 301 determines that the scanner unit 13 is to be used. The switch 407 can be realized by, for example, a FET or a relay switch.

The control signal 410 described above is used for turning on/off the switch 403. When the switch 403 is turned on, the first power is supplied to the controller unit 11. The control signal 410 is switched on when the state notification signal 412 of the main switch 404 or the control signal 411 is switched on. The state notification signal 412 is the signal of the main switch 404 which is controlled by the user. The control signal 411 is controlled by the LAN controller 306. The control signal 410 is used for supplying the first power to the controller unit 11 when the main switch 404 is turned on by the user or the control signal 411 is switched on by the LAN controller 306.

The LAN controller 306 outputs the control signal 411 to control the switch 403. If the LAN controller 306 accepts a job when the main switch 404 is turned off, the control signal 411 turns on the switch 403 so that the first power is supplied to the controller unit 11.

The state notification signal 412 is used for notifying the LAN controller 306 of the state of the main switch 404 and is also used for controlling the main switch 404. If the main switch 404 of the image forming apparatus 10 is turned off according to the determination of the state of the state notification signal 412 by the LAN controller 306, the LAN controller 306 notifies the user that the job cannot be executed unless the main switch 404 is turned on.

The control signal 413 is used for turning on/off the switch 405. When the switch 405 is turned on, the second power is supplied to the controller unit 11, the scanner unit 13, and the printer unit 14. The control signal 413 is controlled by the LAN controller 306. The second power is supplied to the controller unit 11, the scanner unit 13, and the printer unit 14 according to the control signal 413.

The control signal 414 is used for controlling the switch 406 for supplying the second power to the printer unit 14. If the received job is to use the printer unit 14, the controller unit 11 switches on the control signal 414 and supplies power to the printer unit 14. The control signal 415 is used for controlling the switch 407 for supplying the second power to the scanner unit 13. If the received job is to use the scanner unit 13, the controller unit 11 switches on the control signal 415 and supplies power to the scanner unit 13.

A power supply detection circuit 417 detects whether the first power is supplied to the controller unit 11. The power supply detection circuit 417 detects the supply state of the first power to the controller unit 11 and informs the LAN controller 306 of the result of the detection by a first power supply state notification signal 419. A power supply detection circuit 418 detects whether the second power is supplied to the controller unit 11. The power supply detection circuit 418 detects the supply state of the second power to the controller unit 11 and informs the LAN controller 306 of the result of the detection by a second power supply state notification signal 420.

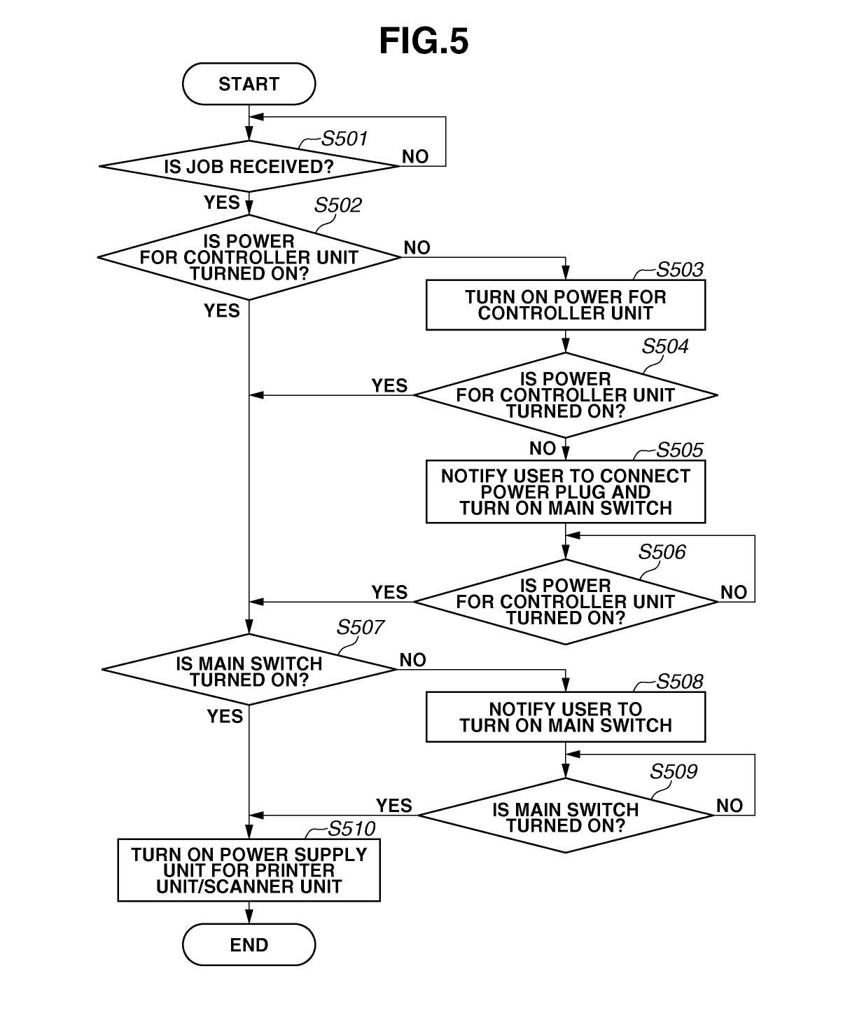

FIG. 5 is a flowchart illustrating an example of the power control processing of the image forming apparatus 10 which is executed when the LAN controller 306 detects a job transmitted via the LAN 60 according to the first exemplary embodiment. The processing of this flowchart is executed by the LAN controller 306. The LAN controller 306 can be configured such that the processing illustrated in FIG. 5 is realized by a processor in the LAN controller 306 reading out a program recorded in a ROM of the LAN controller 306 in a computer-readable manner, and executing the program. Further, the LAN controller 306 can be configured such that the processing illustrated in FIG. 5 is realized by a hardware configuration. The program executed by the processor in the LAN controller 306 can be a program loaded from the ROM 303 into a memory of the LAN controller 306. Each of steps S501 to S510 illustrates each step of the flowchart.

In step S501, the LAN controller 306 determines whether a job is received via the LAN 60. If a job is received via the LAN 60 (YES in step S501), the processing proceeds to step S502.

In step S502, the LAN controller 306 determines whether the power for the controller unit 11 is turned on. This is determined by the following procedures. If the first power and the second power are supplied to the power supply detection circuits 417 and 418 in the controller unit 11, the controller unit 11 notifies the LAN controller 306 that the first power and the second power are supplied using the first power supply state notification signal 419 and the second power supply state notification signal 420. Then, the LAN controller 306 determines whether the power for the controller unit 11 is turned on according to the state of the first power supply state notification signal 419 and the second power supply state notification signal 420.

In step S502, if the power for the controller unit 11 is turned off (NO in step S502), the processing proceeds to step S503. On the other hand, if the power for the controller unit 11 is turned on (YES in step S502), the processing proceeds to step S507.

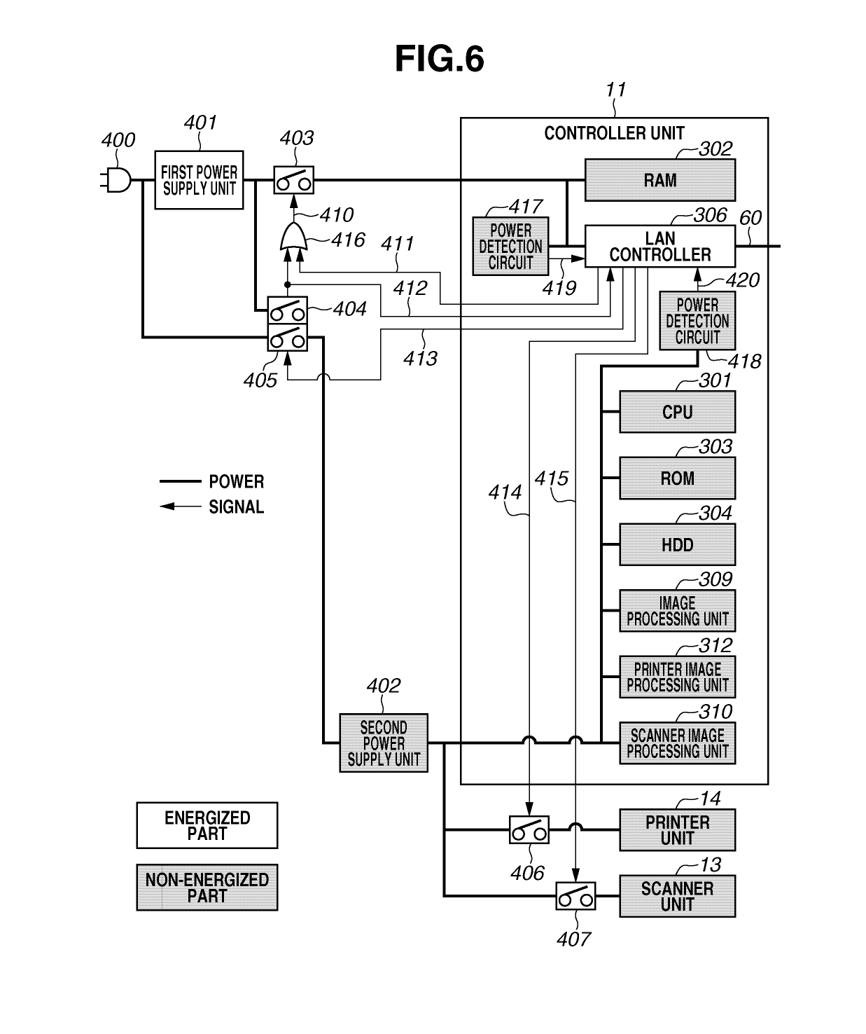

If the power for the controller unit 11 is turned on in step S502 (YES in step S502), the CPU 301 can start execution of various types of processing of the job received via the LAN 60. On the other hand, if the power for the controller unit 11 is turned off (NO in step S502), the power supply state of each device is as illustrated in FIG. 6. More precisely, power is supplied only to the LAN controller 306 by PoE and other devices are not energized. In this state, the CPU 301 cannot start the execution of the various types of processing associated with the job which has been received via the LAN 60.

In step S503, the LAN controller 306 turns on the power for the controller unit 11. The power for the controller unit 11 is turned on by the LAN controller 306 switching on the control signal 411. Then, the switch 403 is turned on and the first power is supplied to the controller unit 11. Further, by the LAN controller 306 switching on the control signal 413, the switch 405 is turned on, and the second power is supplied to the controller unit 11. After the LAN controller 306 switches on the control signals 411 and 413, the processing proceeds to step S504.

In step S504, the LAN controller 306 determines whether the power for the controller unit 11 is turned on. Such determination is performed by a procedure similar to the one described with reference to step S502. If the power for the controller unit 11 is turned off (NO in step S504), the processing proceeds to step S505. On the other hand, if the power for the controller unit 11 is turned on (YES in step S504), the processing proceeds to step S507.

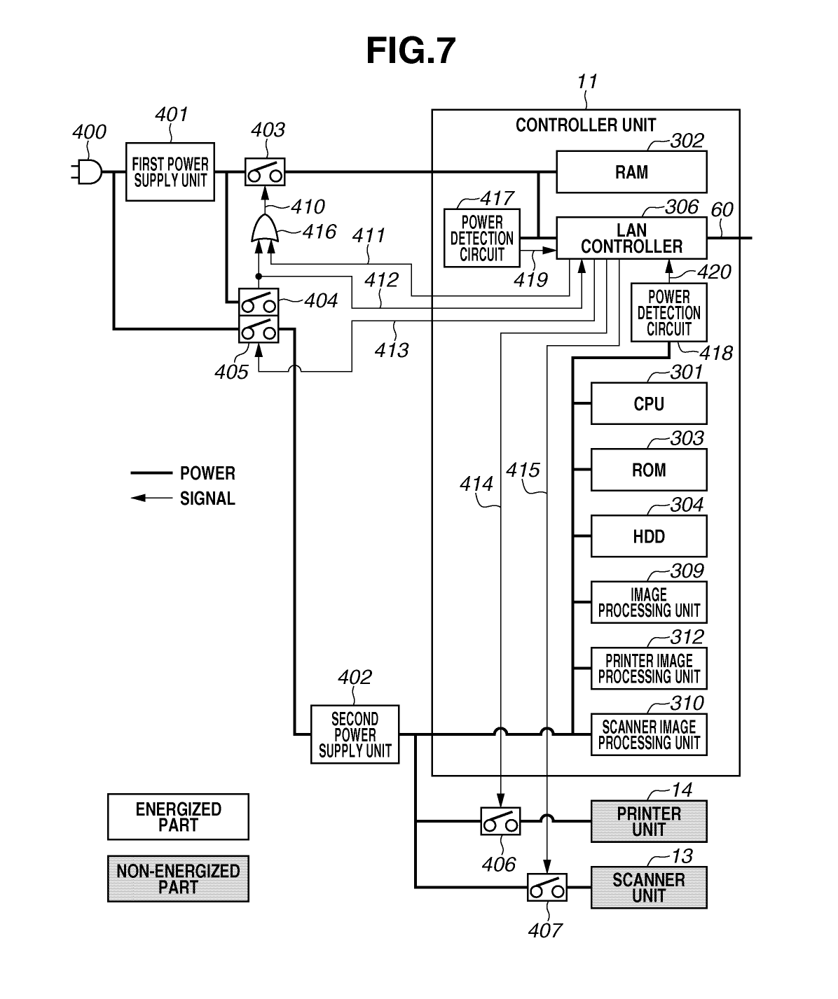

If the power for the controller unit 11 is turned on (YES in step S504), the CPU 301 can start the execution of the various types of processing received via the LAN 60. The power supply state of each device when the power for the controller unit 11 is turned on is as illustrated in FIG. 7. In FIG. 7, power is supplied to the various devices of the controller unit 11, but the scanner unit 13 and the printer unit 14 are in a non-energized state.

In step S505, the LAN controller 306 notifies the user, who submitted the job detected in step S501, to perform AC power connection (e.g., connect image forming apparatus to AC power supply via the power plug 400) and turn on the main switch 404 via the LAN 60. Since it is determined that power is not supplied to the controller unit 11 in step S504, the LAN controller 306 transmits a message notifying the user to perform the AC power connection necessary for the supply of power (e.g., connection of the power plug 400) and turn on the main switch 404. Whether the main switch 404 is turned on is determined by the LAN controller 306 in step S507 described below. The message is sent to the user who submitted the job detected in step S501. In other words, this message is sent to the apparatus that submitted the job detected in step S501. The notification can be a text message or an illustrated image. In this manner, the user, who submitted the job, can easily recognize the state of the image forming apparatus 10, if the job is not executed for a reason such as power not being supplied to the controller unit 11 due to the disconnection of the AC power supply. After the above-described message is sent to the user by the LAN controller 306, the processing proceeds to step S506.

In step S506, the LAN controller 306 determines whether the power for the controller unit 11 is turned on. Such determination is performed by a procedure similar to the one described with reference to step S502. If the power for the controller unit 11 is turned off (NO in step S506), the processing in step S506 is repeated. Alternatively, the processing may also return to step S505. In that case, the above-described message will be sent to the user again.

On the other hand, in step S506, if the power for the controller unit 11 is turned on (YES in step S506), the processing proceeds to step S507. If the power for the controller unit 11 is turned on, the CPU 301 can start the execution of the various types of processing of the job received via the LAN 60. Thus, if the power for the controller unit 11 is turned on, the CPU 301 starts the processing of the job detected in step S501. For example, the CPU 301 interprets the Page Description Language (PDL) in the print job and rasterizes it into a raster image.

In step S507 (YES in any of steps S502, S504 and S506), the LAN controller 306 determines whether the main switch 404 of the image forming apparatus 10 is turned on. The LAN controller 306 determines whether the main switch 404 is turned on by determining the state of the state notification signal 412 which indicates the state of the main switch 404.

In step S507, if the main switch 404 is turned on (YES in step S507), the processing proceeds to step S510. On the other hand, if the main switch 404 is turned off (NO in step S507), the processing proceeds to step S508.

In step S508, the LAN controller 306 sends out a message (e.g., “Turn on the main switch.”) notifying the user, who submitted the job detected in step S501, to turn on the main switch 404 that is in a power off state. In other words, the LAN controller 306 transmits this message to the apparatus that submitted the job (apparatus of the job sender) detected in step S501. Accordingly, the user can easily recognize the state of the image forming apparatus 10 when the submitted job is not executed due to the main switch 404 being turned off. After the message is sent to the user, the processing proceeds to step S509.

In step S509, the LAN controller 306 determines whether the main switch 404 of the image forming apparatus 10 is turned on. This determination is performed by a procedure similar to the one described with reference to step S507.

In step S509, if the main switch 404 is turned on (YES in step S509), the processing proceeds to step S510. On the other hand, if the main switch 404 is turned off (NO in step S509), the processing in step S509 is repeated. Alternatively, the processing may also return to step S508. In that case, the above-described message can be sent to the user again.

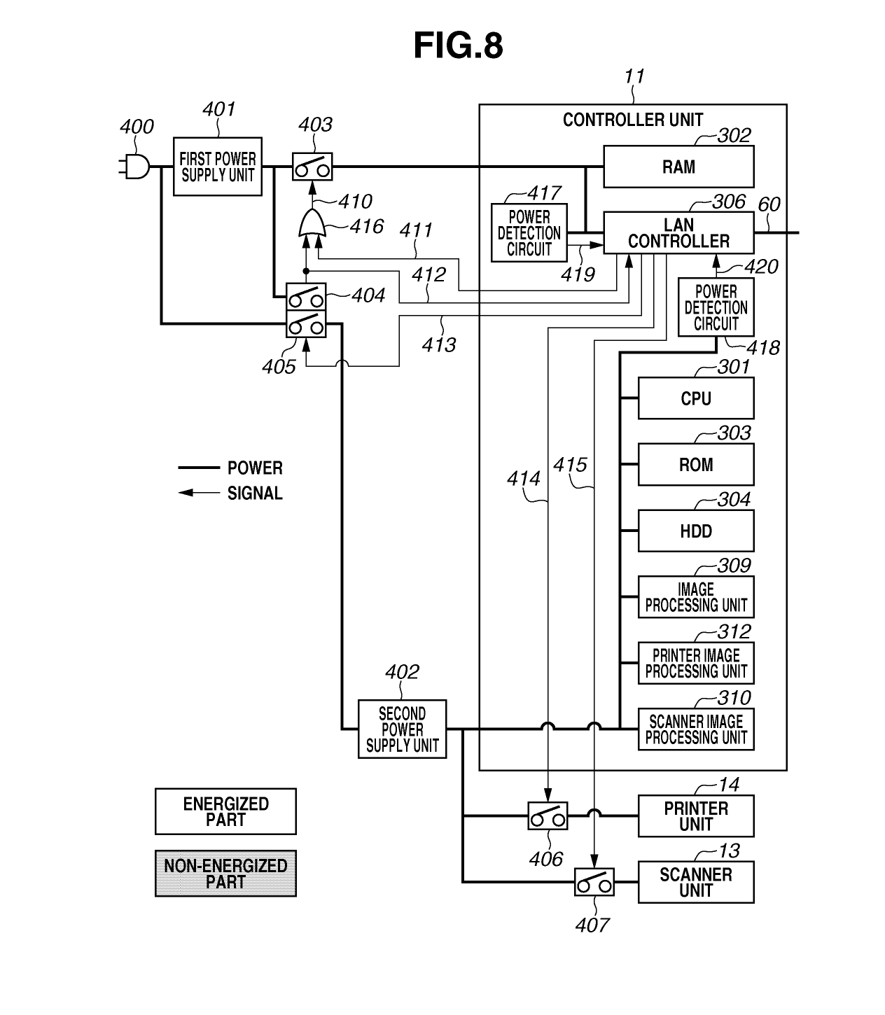

In step S510 (YES in step S507 or step S509), the LAN controller 306 turns on the power for the scanner unit 13 and the printer unit 14. In order to turn on the power supply, the LAN controller 306 switches on the control signal 414 and the control signal 415. Then, the switches 406 and 407 are turned on, and the second power is supplied to the scanner unit 13 and the printer unit 14. The power supply state of each device in a case where the power for the scanner unit 13 and the printer unit 14 is turned on is as illustrated in FIG. 8. In FIG. 8, the entire image forming apparatus 10 is energized. If the LAN controller 306 can determine the type of the job submitted in step S501, the image forming apparatus can be configured such that the power is supplied to either the scanner unit 13 or the printer unit 14 as needed. When the processing in step S510 ends, the processing of the flowchart ends.

As illustrated in FIG. 5, the image forming apparatus 10 according to the present embodiment is controlled such that the power for the scanner unit 13 and the printer unit 14 is not turned on when the main switch 404 is turned off. This is because, when the main switch 404 is turned off, it is extremely unnatural that the power of the scanner unit 13 and the printer unit 14 is turned on and the job is processed by the scanner unit 13 and the printer unit 14. Further, the operation may surprise the user standing by the image forming apparatus, or may be against the intention of the user managing the image forming apparatus.

FIGS. 6 to 8 illustrate examples of the power supply state of the controller unit 11, the scanner unit 13, and the printer unit 14 according to the first exemplary embodiment.

In FIG. 6, the power for the image forming apparatus 10 is turned off, and only the LAN controller 306 is energized by PoE.

In FIG. 7, the main switch of the image forming apparatus 10 is turned off, but the controller unit 11 is energized.

In FIG. 8, the entire image forming apparatus 10 is energized.

Under such circumstances, when the LAN controller 306 having the power supplied by PoE detects a job sent via the LAN 60, it can determine the state of the power supply and the power control of the controller unit 11 and the state of the main switch 404 of the image forming apparatus 10. Then, the LAN controller 306 can notify the user who submitted the job of the power supply state/switch state of the image forming apparatus 10. Further, by the LAN controller 306 performing power supply control of the controller unit 11, when a job is submitted in a state where power is not supplied to the controller unit 11, power can be supplied to the controller unit 11 before the entire image forming apparatus 10 is turned on. Since the CPU 301 in the controller unit 11 becomes operable in advance, job processing can start before the entire image forming apparatus 10 is turned on.

According to the first exemplary embodiment described above, the LAN controller 306 is energized via the LAN 60. According to a second exemplary embodiment, the communication controller is energized via a communication interface different from the LAN. More precisely, a case where a USB controller is energized via a USB will be described according to the present embodiment.

The controller unit 11 according to the present embodiment is similar to the configuration of the controller illustrated in FIG. 3 except that a USB controller 901 is added to the configuration. The USB controller 901 can be provided in place of the LAN controller 306.

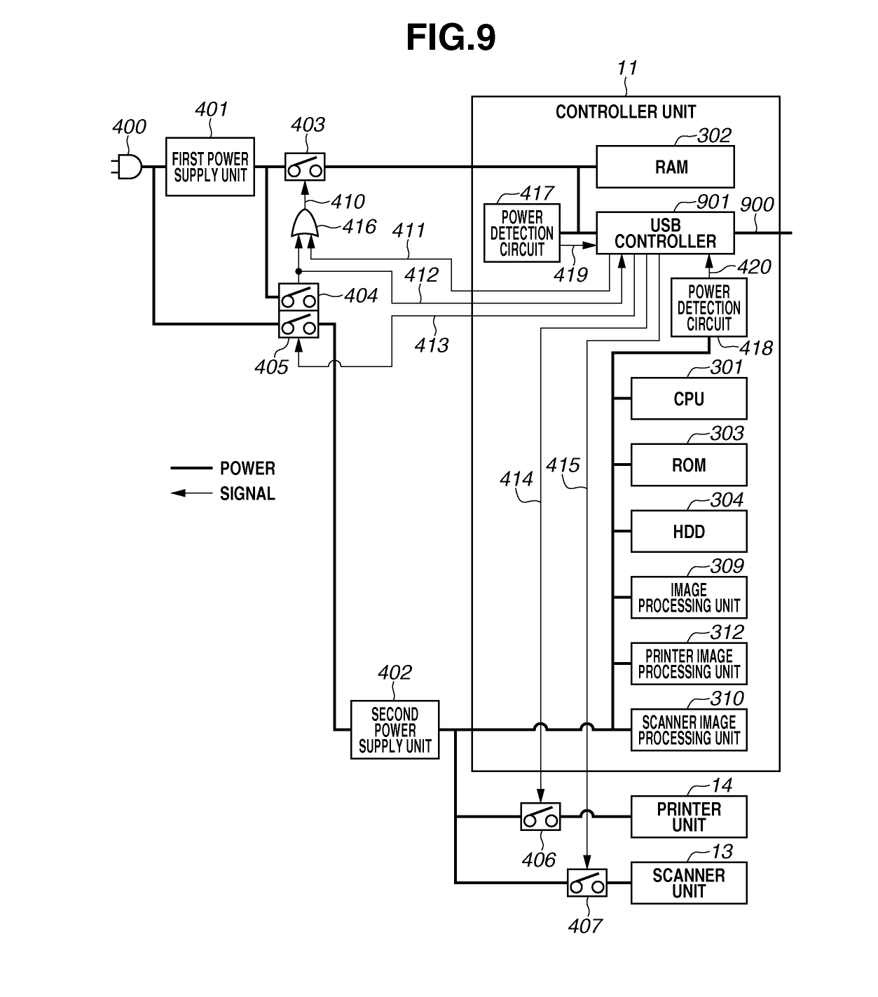

FIG. 9 is a block diagram of a hardware configuration of the controller unit 11, the scanner unit 13, and the printer unit 14 associated with the power control according to the second exemplary embodiment. The components similar to those illustrated in FIG. 4 are given the same reference numerals.

The USB controller 901 connects a USB 900 and the system bus 307 (see FIG. 3). The USB controller 901 is a communication control unit which controls input/output of information associated with data communication with the external apparatus via the USB 900. Further, the USB controller 901 includes a power receiving unit of VBUS via the USB 900 and can receive power via a USB cable even if the power supply of the main body of the image forming apparatus 10 is turned off. Thus, the USB controller 901 can operate by the power supplied via the USB 900 as well as by the power supplied from the power source of the image forming apparatus 10.

The components other than the USB controller 901 are similar to those of the first exemplary embodiment. The flowchart of the power supply control processing illustrated in FIG. 5 according to the first exemplary embodiment can be used for the present embodiment by replacing the LAN controller 306 with the USB controller 901 as the controller of the power supply control processing. Further, the job detection via the LAN 60 performed in step S501 will be interpreted as a job detection via the USB 900.

The USB controller 901 can be configured such that the processing such as the one illustrated in FIG. 5 is realized by a processor in the USB controller 901 reading out a program recorded in a ROM of the USB controller 901 in a computer-readable manner and executing the program. Further, the USB controller 901 can be configured such that the processing such as the one illustrated in FIG. 5 is realized by a hardware configuration. The program executed by the processor in the USB controller 901 can be a program loaded from the ROM 303 into a memory of the USB controller 901.

Under such circumstances, when the USB controller 901 having the power supplied by the USB detects a job sent via the USB, it can determine the state of the power supply and the power control of the controller unit 11 and the state of the main switch 404 of the image forming apparatus 10. Then, the USB controller 901 can notify the user, who submitted the job, of the power supply state/switch state of the image forming apparatus 10. Further, by the USB controller 901 performing power supply control of the controller unit 11, when a job is submitted in a state where power is not supplied to the controller unit 11, power can be supplied to the controller unit 11 before the entire image forming apparatus 10 is turned on. Since the CPU 301 in the controller unit 11 becomes operable in advance, job processing can start before the entire image forming apparatus 10 is turned on.

Further, the controller unit 11 may be configured such that the LAN controller 306 executes the processing according to the first exemplary embodiment if the LAN controller 306 determines that the job has been submitted via the LAN 60, and the USB controller 901 executes the processing according to the second exemplary embodiment if the USB controller 901 determines that the job has been submitted via the USB 900. Accordingly, the effects of both the first and the second exemplary embodiments can be obtained.

Furthermore, submission of a job is not limited to via a LAN or a USB. For example, a job can be received via a communication medium of a different communication standard capable of supplying power (e.g., Thunderbolt). In this case, a controller that controls the input/output of data via the communication medium performs the processing similar to the processing performed by the LAN controller 306 and the USB controller 901.

Now, processing which is performed when a host computer transmits a job for detecting a state of the image forming apparatus 10 via a communication medium (e.g., the LAN 60 or the USB 900) to the image forming apparatus 10 will be described. When the communication controller (the LAN controller 306 or the USB controller 901) of the image forming apparatus 10 receives a job for detecting the state of the image forming apparatus 10, the controller determines whether the power for the controller is turned on (as is performed in step S502), determines whether the main switch 404 is turned on (as is performed in step S507), and sends out a message to the job sender including at least whether the power for the controller is turned on/off according to the result of the determination or whether the main switch 404 is turned on/off according to the result of the determination (as is performed in steps S505 and S508). In this case, the power supply unit for the printer unit 14 and the scanner unit 13 is not turned on.

Even if the power supply of the apparatus main body is turned off, when a controller that controls input/output via a communication medium operates by a battery or a solar panel, the exemplary embodiment(s) is also applicable even if the communication medium cannot supply power.

Although the image forming apparatus 10 is described as a representative apparatus, image forming apparatuses 20 and 30 can be used as the representative apparatus. Further, electronic apparatuses other than the image forming apparatus are applicable. For example, the present any type of electronic apparatus that can receive a job via a communication medium and process it.

As described above, when power can be supplied to the image forming apparatus via a communication medium (e.g., LAN or USB) even if the main body of the image forming apparatus is turned off, the state of the power for the image forming apparatus and the state of the main switch which can be turned on/off by the user can be determined. Thus, the state of the power supply and the main switch can be notified to the user.

For example, even if a job is submitted to the image forming apparatus via a communication medium when the external power is not supplied to the image forming apparatus for a reason such as a disconnected power plug or a turned-off main switch, the user can easily recognize the supply state of the external power and the state of the main switch of the image forming apparatus.

Further, even if the main switch of the image forming apparatus is turned off, when a job is received, the controller that performs data processing of the job can start. Accordingly, the data processing of the job can start before the main switch is turned on. As a result, the time required from when the main switch is turned on to when the job is completed can be reduced.

The configuration and content of data is not limited to the various types of data described above, and can be configured to have various configurations and contents according to its purpose or application.

Although exemplary embodiments are illustrated in the description above, various other embodiments are applicable, such as a system, an apparatus, a method, a program, or a storage medium. In other words, exemplary embodiments can be applied to a system including a plurality of apparatuses (e.g., computer, interface apparatus, reader, printer and such) or to an apparatus configured from one apparatus (e.g., electronic apparatus such as a multifunction peripheral, printer, fax machine apparatus and such).

A combination of each of the above-described exemplary embodiments is also applicable.

The above described embodiments can be applied to a system including a plurality of devices, or to an apparatus including a single device.

The above-described exemplary embodiments are not seen to be limiting, and various changes and modifications (including organic integration of the exemplary embodiments) can be applied. In other words, each of the above-described exemplary embodiments and a combination of its alternate versions are applicable.

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-106094 filed May 20, 2013, which is hereby incorporated by reference herein in its entirety.

What is claimed is:

1. An image forming apparatus having a switch turned on or off according to an operation of a user, the apparatus comprising:
a control unit configured to control the image forming apparatus;
a network interface unit configured to receive data transmitted from an external apparatus; and
a power supply unit configured to supply power to the control unit if the network interface unit receives a wake-up request transmitted from the external apparatus in a state where power is supplied to the network interface unit via a network cable that connects the network interface unit and a network.

2. The image forming apparatus according to claim 1, further comprising:
a switch arranged between the power supply unit and the control unit; and
a switch control unit configured to control the switch such that power is supplied to the control unit if the network interface unit receives the wake-up request transmitted from the external apparatus in a state where power is supplied to the network interface unit via the network cable.

3. The image forming apparatus according to claim 1, further comprising:
an image forming unit configured to form an image on paper,
wherein the power supply unit supplies power to the image forming unit if the network interface unit receives the wake-up request in a state where power is supplied to the network interface unit via the network cable.

4. The image forming apparatus according to claim 3, wherein the power supply unit supplies power to the image forming unit when the switch is turned on.

5. The image forming apparatus according to claim 3, wherein the power supply unit does not supply power to the image forming unit if the switch is turned off.

6. The image forming apparatus according to claim 3, further comprising:
a switch arranged between the power supply unit and the image forming unit; and
a switch control unit configured to control the switch such that power is supplied to the image forming unit if the network interface unit receives the wake-up request transmitted from the external apparatus in a state where power is supplied to the network interface unit via the network cable.

7. The image forming apparatus according to claim 1, further comprising:
a reading unit configured to read an image of a document,
wherein the power supply unit supplies power to the reading unit if the network interface unit receives the wake-up request in a state where power is supplied to the network interface unit via the network cable.

8. The image forming apparatus according to claim 7, wherein the power supply unit supplies power to the reading unit when the switch is turned on.

9. The image forming apparatus according to claim 7, wherein the power supply unit does not supply power to the reading unit if the switch turned off.

10. The image forming apparatus according to claim 7, further comprising:
a switch arranged between the power supply unit and the reading unit; and
a switch control unit configured to control the switch such that power is supplied to the reading unit if the network interface unit receives the wake-up request transmitted from the external apparatus in a state where power is supplied to the network interface unit via the network cable.

11. The image forming apparatus according to claim 1, further comprising:
a display unit configured to display information,
wherein the power supply unit supplies power to the display unit if the network interface unit receives the wake-up request in a state where power is supplied to the network interface unit via the network cable.

12. The image forming apparatus according to claim 11, wherein the display unit displays a screen asking a user to turn on the switch.

13. A control method for an image forming apparatus having a switch turned on or off according to an operation of a user, the method comprising:
supplying power to a network interface unit via a network cable that connects a network interface unit and a network if the switch is turned off; and
supplying power to a control unit that controls the image forming apparatus if the network interface unit receives a wake-up request transmitted from an external apparatus in a state where power is supplied to the network interface unit via the network cable.

14. A computer-readable storage medium for storing computer executable instructions that cause a computer to execute a method, the method comprising:
supplying power to a network interface unit via a network cable that connects a network interface unit and a network if the switch is turned off; and
supplying power to a control unit that controls the image forming apparatus if the network interface unit receives a wake-up request transmitted from an external apparatus in a state where power is supplied to the network interface unit via the network cable.
